(19) United States
(12) Patent Application Publication
(10) Pub. No.: US 2026/0252618 A1
(43) Pub. Date: Aug. 27, 2026

(54) SYSTEMS AND METHODS FOR GENERATING AN AGGREGATION REPORT BASED ON A SET OF AGGREGATED VALUES

(71) Applicant: People Center, Inc., San Francisco, CA (US)

(72) Inventors: Sudhir Krishnakumar, San Francisco, CA (US); Vijay Daniel M, Bengaluru (IN); Kushagra Singhal, Bengaluru (IN); Vivin Flawence Peris, San Francisco, CA (US); Pankaj Birat, Bengaluru (IN); Jason Liu, San Francisco, CA (US); Dhananjay Pugalendi, Bengaluru (IN)

(21) Appl. No.: 19/177,112

(22) Filed: Apr. 11, 2025

(30) Foreign Application Priority Data
Feb. 21, 2025 (IN) 202511015039

(51) Int. Cl. G06F 16/35

(52) U.S. Cl. CPC G06F 16/35

(57) ABSTRACT

Systems and methods for generating an aggregation report based on a set of aggregated values are provided. The system includes one or more processors; and one or more transitory or non-transitory computer-readable media storing instructions that are executable to cause the one or more processors to perform operations, the operations comprising: receiving a set of aggregation criteria; retrieving a set of data objects comprising one or more values corresponding to one or more data fields based on the set of aggregation criteria; classifying the set of data objects into one or more subsets of data objects; generating a set of aggregated values by aggregating at least one value of the one or more values associated with each subset of data objects of the one or more subsets of data objects using an aggregation engine; and generating an aggregation report based on the set of aggregated values.

### CROSS-REFERENCE TO PRIORITY APPLICATION

This application claims priority to Indian Application No. 202511015039 filed Feb. 21, 2025, the entirety of which is incorporated by reference herein.

### FIELD

The present disclosure relates generally to systems and methods for generating an aggregation report based on a set of aggregated values.

### BACKGROUND

Accumulating and aggregating data objects presents a significant technical challenge, especially when dealing with large, diverse datasets across multiple sources. The core issue lies in efficiently collecting, processing, and combining data without overwhelming the system's computing resources. The technical challenge is further compounded when the available computing power is limited to a single device. Traditional methods for data accumulation often require extensive computing power due to the complexity of managing multiple data sources, handling large volumes of real-time data, and performing computationally intensive aggregation operations. These methods may rely on parallel processing, distributed systems, or cloud-based infrastructures, all of which can be costly and impractical when limited to a single machine.

Accordingly, improved systems and methods for generating an aggregation report based on a set of aggregated values are desired in the art. In particular, systems and methods for generating an aggregation report based which provide improved methods for conserving computational power would be advantageous.

### BRIEF DESCRIPTION

Aspects and advantages of the invention in accordance with the present disclosure will be set forth in part in the following description, or may be obvious from the description, or may be learned through the practice of the technology.

In accordance with one embodiment, a system for generating an aggregation report based on a set of aggregated values is provided. The system includes one or more processors; and one or more transitory or non-transitory computer-readable media storing instructions that are executable to cause the one or more processors to perform operations, the operations comprising: receiving a set of aggregation criteria; retrieving a set of data objects comprising one or more values corresponding to one or more data fields based on the set of aggregation criteria; classifying the set of data objects into one or more subsets of data objects; generating a set of aggregated values by aggregating at least one value of the one or more values associated with each subset of data objects of the one or more subsets of data objects using an aggregation engine; and generating an aggregation report based on the set of aggregated values.

In accordance with another embodiment, a method for generating an aggregation report based on a set of aggregated values is provided. The method includes receiving, using a computing device, a set of aggregation criteria; retrieving, using the computing device, a set of data objects comprising one or more values corresponding to one or more data fields based on the set of aggregation criteria using an accumulation engine; classifying, using the computing device, the set of data objects into one or more subsets of data objects; generating, using the computing device, a set of aggregated values by aggregating at least one value of the one or more values associated with each subset of data objects of the one or more subsets of data objects using an aggregation engine; generating, using the computing device, an aggregation data structure based on the set of aggregated values and the one or more subsets of data objects; and generating, using the computing device, an aggregation report using the aggregation data structure.

In accordance with one embodiment, a system for generating an aggregation report based on a set of aggregated values is provided. The system includes one or more processors; and one or more transitory or non-transitory computer-readable media storing instructions that are executable to cause the one or more processors to perform operations, the operations comprising: receiving a set of aggregation criteria; retrieving a set of data objects comprising one or more values corresponding to one or more data fields based on the set of aggregation criteria using an accumulation engine; classifying the set of data objects into one or more subsets of data objects, classifying the set of data objects comprises: normalizing the set of data objects using a normalization process; and flattening the normalized set of data objects using a data flattening process; generating a set of aggregated values by aggregating at least one value of the one or more values associated with each subset of data objects of the one or more subsets of data objects using an aggregation engine; generating an aggregation data structure based on the set of aggregated values and the one or more subsets of data objects; generating an aggregation report using the aggregation data structure.

These and other features, aspects, and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a block diagram of an exemplary system for generating an aggregation report based on a set of aggregated values in accordance with embodiments of the present disclosure;

FIG. 2 is a flow diagram of an exemplary method for training the aggregation engine to generate the set of aggregated values in accordance with embodiments of the present disclosure;

FIG. 3 is a block diagram of an exemplary system for generating and maintaining an aggregation data structure in accordance with embodiments of the present disclosure;

FIG. 4 is a flow diagram of an exemplary method for generating an aggregation report based on a set of aggregated values in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than a limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure is directed to systems and methods for generating an aggregation report based on a set of aggregated values. The system may be used to effectively generate the aggregation report in circumstances where computing power is limited. This may be done with the goal of efficiently combining, processing, and presenting data from multiple sources into an aggregation report using a single computing device. The disclosed systems and methods may be designed to reduce the strain on the computing system.

Rather than relying on computing clusters or cloud servers, the systems and methods disclosed herein may be optimized for environments with constrained computing power. The disclosed systems and methods may implement techniques such as incremental computation or distributed aggregation to conserve computing resources while generating the aggregation report. In some cases, the systems and methods disclosed herein may include employing lightweight and efficient aggregation algorithms or machine-learning models to generate comprehensive reports without overwhelming the device's capabilities.

Systems and methods disclosed herein may include retrieving a set of data objects, wherein each data object includes one or more values corresponding to one or more data fields. As used in the current disclosure, a data object refers to a discrete unit of data that includes one or multiple values across various fields, each of which holds specific information. Each field within a data object may represent a distinct category of information pertinent to the object's purpose or function. For instance, in a customer database, the data object might include fields such as customer name, address, phone number, and email. Each of these fields may contain specific values that collectively define a complete record for a particular customer. Data objects may be designed to facilitate efficient storage, retrieval, and manipulation of information. They serve as a structured format for organizing data, ensuring that related pieces of information are grouped together in a coherent manner. This structure is beneficial for managing complex datasets, as it allows for systematic access and modification of the data. For example, a data object related to an employee record might include fields for employee ID, job title, department, salary, and tax data, all of which are useful for employee management and reporting.

Data objects can exhibit varying levels of complexity based on the specific requirements of the application in which they are used. In an embodiment, a data object may encompass a number of fields with direct values. For example, a basic contact information data object might include fields such as name, phone number, and email address. Each field in this simple object contains a single, discrete piece of data. As the complexity of the application increases, so too can the complexity of the data objects. More sophisticated data objects can incorporate nested structures, hierarchical relationships, and/or multi-dimensional data representations. This may allow the data objects to capture more detailed and nuanced information. For instance, consider an invoice data object used in an accounting system. This object might include primary fields such as invoice numbers, issue dates, and customer information, but it could also contain nested fields to provide a more comprehensive view.

Data objects that have a nested structure might include sub-fields. For example, this may include sub-fields for payroll data, where each payment could have one or more fields related to pay roll tax, bonus, date of payment, tax data, and total amount. Additionally, the sub-fields may include fields for payment status, including sub-fields for payment date, method, and confirmation number. These nested sub-fields allow for detailed tracking of each charge and payment.

Hierarchical relationships may further increase the complexity of data objects. In some systems, data objects may be organized in a tree-like structure where parent objects contain child objects, each of which may have its own set of sub-objects. This hierarchical approach is useful for representing data with multiple levels of detail. For instance, a project management system might use hierarchical data objects to manage project details, where a top-level project object contains nested tasks, each with its own subtasks and related resources.

Systems and methods disclosed herein may include retrieving the data objects using an accumulation engine. The accumulation engine may be a software module designed to accumulate data objects from a variety of sources, efficiently collecting and storing raw data for further processing. The role of the accumulation engine is to retrieve data from distributed systems, APIs, or internal databases, filtering, and organizing the information in a way that makes it easier to analyze. The Accumulation Engine may employ lightweight machine learning models, such as classification or clustering algorithms, to intelligently prioritize which data to collect, based on factors like historical trends or relevance. This enables the engine to optimize data retrieval, ensuring that it only gathers the most pertinent information while minimizing redundant or irrelevant data.

Systems and methods disclosed herein may also include generating an aggregated value based on the subset of data objects. The aggregated value created from a subset of data objects represents a consolidated result derived from combining individual data points within that subset of data objects. This could include summing, averaging, or applying other statistical operations to the data objects, depending on the intended outcome.

Systems and methods disclosed herein may employ an aggregation engine to generate the aggregated values. As used in the current disclosure, the aggregation engine refers to a software module that processes the subset of data objects to generate aggregated results. These aggregated values may include but are not limited to sums, averages, or other statistical measures that combine information from multiple data objects into a single, unified output. The aggregation engine may be configured to handle large volumes of data efficiently by applying optimized algorithms for aggregation, such as incremental sum or weighted averages. Like the accumulation engine, the aggregation engine may also leverage lightweight machine learning models to refine its aggregation strategies over time.

In some cases, the system and methods disclosed herein may include generating an aggregation report based on the set of aggregated values. An aggregation report is a structured summary that compiles and presents aggregated data in a clear and actionable format. The aggregation report may be generated after data objects have been accumulated and processed, the report may highlight metrics and insights derived from the aggregated values. For instance, an aggregation report could include total sales, average employee salaries, or overall tax liabilities across a given period or region. The aggregated report may be designed to condense large amounts of raw data into digestible insights.

The aggregation report may be generated based on querying an aggregation data structure. As used in the current disclosure, the aggregation data structure may be designed to house subsets of data objects and their corresponding aggregated values in a way that facilitates efficient storage, retrieval, and computation. It serves as a container for organizing raw data and the results of aggregation operations, enabling users or systems to quickly access both individual data points and their consolidated summaries. The structure may organize the data objects and other values using a data hierarchy or tabular formats, with each subset of data objects representing a distinct group or category.

In some cases, before storing data objects in the aggregation data structure, systems and methods disclosed herein may be used to flatten and normalize the data objects to ensure consistency and optimize performance. Flattening involves transforming nested or complex data structures, such as JSON objects or relational records, into a simplified, tabular format where each data element is represented as a discrete value. This step ensures that all relevant information is accessible in a single-level format, eliminating the need for deep hierarchies or complex joins during data retrieval.

Normalization further refines the data objects by standardizing values across different units or scales. For instance, numerical values like salary or sales figures might be normalized to a common scale or converted to a uniform unit (e.g., all amounts expressed in thousands of dollars). This ensures that comparisons between different data objects or aggregated values are consistent and meaningful.

Once the data is flattened and normalized, it may be stored in the aggregation data structure, where it can be efficiently queried and updated. The aggregation data structure may use techniques like indexing or caching to speed up aggregation operations, allowing for faster calculations of totals, averages, or other metrics across large datasets. By separating the raw data objects from their aggregated summaries, the structure enables quick recalculations or adjustments if new data is added or existing values change.

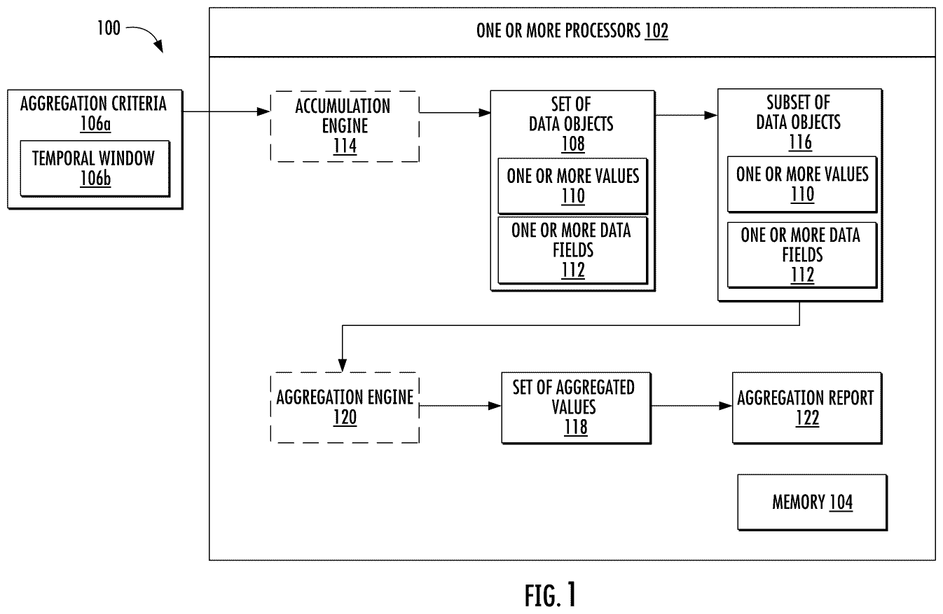

Referring now to FIG. 1, a block diagram of a system for generating an aggregation report based on a set of aggregated values. FIG. 1 includes a processor 102, a memory 104, aggregation criteria 106a, a temporal window 106b, data objects 108, values 110, data fields 112, an accumulation engine 114, a subset of data objects 116, a set of aggregated values 118, an aggregation engine 120, an aggregation report 122, and the like.

System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series and/or in parallel. The one or more processors 102 may be dedicated to a particular computing device and/or may be utilized by a plurality of devices to perform processing tasks.

Processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. This may be used to train, refine, or otherwise improve any algorithm. Machine-learning model, neural network, and the like mentioned herein. This includes but is not limited to both the aggregation engine 120 and the accumulation engine 114.

Processor 102 may include a single computing device operating independently, or may include two or more computing devices operating in concert, in parallel, sequentially or the like; two or more computing devices may be included together in a single computing device or in two or more computing devices. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more operations as described below across a plurality of computing devices, which may operate in parallel, in series, redundantly, or in any other manner used for the distribution of tasks or memory between computing devices.

System 100 may include memory 104 which can store data and/or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 may cause system 100 to perform operations as described herein.

Memory 104 may store data and/or instructions associated with one or more applications. The one or more applications can include native, factory-set applications and/or downloaded applications. The applications may include one or more messaging applications, one or more image capture applications, one or more social media applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for generating an aggregation report based on a set of aggregated values.

With continued reference to FIG. 1, the operations include receiving a set of aggregation criteria 106a. As used in the current disclosure, aggregation criteria 106a refers to a defined set of filtering criteria that are applied during the retrieval process of the collection of data objects 108. These criteria may serve as rules or conditions that guide the system in identifying and selecting the relevant data objects that need to be retrieved for further processing or analysis. Rather than retrieving all available data objects 108, the aggregation criteria 106a can help the system focus on specific data points that meet certain conditions. Exemplary aggregation criteria 106a may include a variety of factors such as temporal windows 106b, geographical region (e.g., cities, states, zip codes, geofenced areas, political districts, countries, and the like), and data categories (e.g., sales, payroll, tax data, expenses, or profits) to group data by relevant classifications. Other filtering criteria might include job title or job function to segment employee-related data, employee classification (e.g., full-time, part-time, high risk, or contractor) to differentiate types of employees, and salary range to focus on specific compensation brackets. Tax data might also be used as a criterion to filter based on different tax categories such as federal or state taxes.

With continued reference to FIG. 1, the set of aggregation criteria 106a may include a temporal window 106b. As used in the current disclosure, a temporal window 106b is a defined period of time used to segment and analyze data. The temporal window 106b may be used to aggregate, analyze, or report data within specific time intervals. The temporal window 106b may help organize time-sensitive information by breaking down large, continuous datasets into manageable chunks. The temporal window 106b may serve as a data input that defines which portion of the data should be considered for processing. By applying the temporal window 106b, system 100 can focus on a particular subset of data corresponding to a specific time frame, such as days, weeks, months, or years. The size of the temporal window can vary depending on the level of granularity needed. Exemplary temporal windows 108b might include hourly, daily, weekly, monthly, quarterly, seasonally, semi-annually, annually, biennially, per decade, and similar intervals.

In an embodiment, the temporal window 106b may be used in systems that rely on windowed computations. For instance, system 100 may use a sliding window approach, where each temporal window may move forward by a fixed interval, processing new data while potentially discarding older data outside the current window.

With continued reference to FIG. 1, the operations include retrieving a set of data objects 108 comprising one or more values 110 corresponding to one or more data fields 112. In an embodiment, the set of data objects 108 may be defined according to a schema, which delineates the data fields 112 and the permissible values 110 for each field. This schema may be applied across each data object that is discussed herein, including but not limited to the set of data objects, the second set of data objects, the third set of data objects, up to and including the nth data object.

The set of data objects 108 may encompass a variety of information. These data fields 112 represent distinct categories or attributes pertinent to the data object 108, and the values 110 assigned thereto can encompass a broad spectrum of information types. Such information may include but is not limited to numerical data, textual content, dates, human resource data, job title, job category, salary, tax data, payroll data, or other relevant data types that the data fields are structured to accommodate. The values 110 contained within each data object 108 may be recorded and stored in accordance with the defined data fields 112.

In an embodiment, the set of data objects 108 may encompass a wide variety of human resource information. The set of data objects 108 may be used to capture and manage details related to an individual employee within an organization. In a non-limiting example, the set of data objects 108 may include fields 112 for an employee ID, the employee's full name, date of birth, gender, phone number, email address, and contact details including address fields for the employee's current residential location.

Additionally, the set of data objects 108 may include employment-related details, including the employee's job title, department, employment status, supervisor, job title, job function, discretionary and key dates such as the start and, if applicable, end date of employment. Fields 112 within the set of data objects 108 may be directed to compensation and benefits information for the employee. This may include information related to the employee's salary, payment frequency, tax information, salary, payroll taxes, tax data, tax withholdings, and benefits such as health insurance and retirement plans. The set of data objects 108 may include educational qualifications, certifications, and credentials relevant to the employee's role. Performance records may be included within the set of data objects 108, this may include fields 112 documenting evaluations, feedback, and any disciplinary actions, as well as employment history detailing prior roles and responsibilities.

The set of data objects 108 may encompass tax data. As used in the current disclosure, tax data refers to information related to the various taxes an entity may be obligated to pay to governmental authorities. This data may include a wide array of tax types, such as sales tax, payroll tax, property tax, excise taxes, and the like. Tax data may also include taxes on vehicles, equipment, and other forms of tangible or intangible property, depending on the jurisdiction and the entity's activities. Payroll tax data may include information related to the taxes an employer is required to withhold from employee wages and the employer's own tax contributions. This data may include information related to federal, state, and local income tax withholdings, as well as Social Security and Medicare taxes (FICA), unemployment insurance taxes, and the like. Payroll tax data may include information about the gross wages paid to employees, the amount withheld for each type of tax, and any employer contributions required by law.

In an embodiment, the set of data objects 108 may include a first plurality of key value pairs, each key value pair comprising a value for a key. As used in the current disclosure, a key-value pair refers to a data structure consisting of two interrelated components: a key and the value 110. Each key is designed to be unique within its specific context or data structure, ensuring that no two keys can be identical within the same scope. In some embodiments, the key acts as an index or lookup identifier that directs the system to the correct value, thereby streamlining data operations and minimizing the risk of errors.

Together, the key and value form a pair that allows for efficient data management and retrieval. For instance, in a database, a key-value pair might be used to store user information, where the key could be a unique user ID and the value could be a set of details such as name, salary, tax data, email address, and phone number. When a query is made using a user ID (the key), the system quickly retrieves the associated user details (the value).

With continued reference to FIG. 1, the operations may include retrieving a set of data objects 108 using an accumulation engine 114. As used in the current disclosure, the accumulation engine 114 is a specialized system or software component designed to identify and gather data objects 108 from multiple sources. The accumulation engine 114 may be used to collect data from various origins, such as websites, databases, and external systems, to create a repository or dataset. In order to gather data from various sources, the accumulation engine 114 may use a combination of data retrieval techniques that prioritize efficiency and resource conservation. When retrieving data from databases, the accumulation engine 114 may interact with internal or external databases via queries or aggregation criteria 106a that are designed to pull only the relevant data objects. For instance, rather than retrieving the entire database or large tables, the accumulation engine 114 may use selective queries based on specific filters, such as temporal windows, aggregation criteria, job titles, job categories, and the like. These queries ensure that only a small, focused subset of data is retrieved at any given time. Additionally, the accumulation engine 114 can implement pagination techniques, which allow it to retrieve data in smaller, manageable chunks instead of loading entire datasets into memory all at once.

To minimize computing power while retrieving data from multiple sources, the accumulation engine 114 can implement a distributed or parallel data collection strategy. In this embodiment, rather than retrieving data sequentially from each source, the engine can initiate parallel requests to various APIs or databases. These parallel requests can be made asynchronously, ensuring that the system does not block while waiting for responses, thus allowing the accumulation engine 114 to collect data efficiently without requiring significant computational resources. Each source can process its query independently, and the engine can aggregate the results as they come in.

Once the data is retrieved, the accumulation engine 114 may use incremental processing to handle large datasets without needing to load all the data into memory at once. Instead of processing the entire dataset upfront, the accumulation engine 114 may process the data incrementally as it is retrieved, allowing for continuous operations without requiring large amounts of RAM or CPU power.

The accumulation engine 114 may be configured to retrieve the data objects 108 from various data sources, such as an application program interface (API). The API may allow the accumulation engine 114 to retrieve data from external services or systems in a structured and automated manner. APIs offer a direct and efficient way for the accumulation engine 114 to access real-time or periodically updated data from sources such as cloud services, enterprise applications, third-party software, and more. The accumulation engine 114 may be configured to pull specific datasets, making it easier to retrieve just the relevant data points without needing to interact with the entire database or service.

The accumulation engine 114 may also use web crawlers to search and collect data from publicly available websites or other online sources. The web crawler may be used to systematically browse the web by following links between pages to discover and retrieve data that meets certain criteria. For example, the accumulation engine 114 could be configured to crawl websites, databases, internal websites to gather data objects 108.

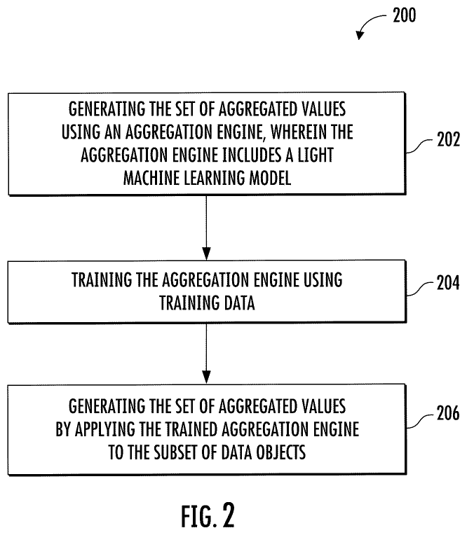

In some cases, the accumulation engine 114 may include an algorithm or light machine-learning model. The accumulation engine 114 may employ algorithms or light machine-learning models to access data across multiple platforms or repositories. Once data is fetched, the algorithms or light machine-learning models may use filtering or transformation algorithms to ensure that only relevant objects are retained and merged into the overall dataset. In some cases, the algorithms or light machine-learning model of the accumulation engine 114 may be the same or substantially similar to the algorithms or light machine-learning models discussed herein below for the aggregation engine 120 in FIG. 2. Additionally, the process of training the accumulation engine 114 may be the same or substantially similar to the processes that are discussed herein below in FIG. 2.

With continued reference to FIG. 1, the operations include classifying the set of data objects 108 into a plurality of subsets of data objects 116. As used in the current disclosure, the subsets of data objects 116 refer to categorized groups that emerge after the classification process. Each subset of data objects 116 may include data objects 108 that meet the same set of filtering or classification criteria. These subsets might be based on a range of factors, such as temporal factors, geographical factors, demographic factors, human resource factors, (e.g., grouping employees by age, tenure, gender, salary, job title, company, department), and the like.

The process of classifying the data objects 108 into subsets of data objects 116 may include defining the classification criteria. These classification criteria can be defined based on a variety of factors. For instance, classification might be based on time periods (e.g., quarterly or monthly) , employee categories, employee salary, company, department, job title, or geographic regions. Once the criteria are determined, the system systematically checks each data object 108 to see if it meets the conditions for a given subset.

In an embodiment, system 100 can use various algorithms, light machine-learning models, or data structures to classify data objects. Classification of the data objects 106 may include categorizing the data objects 106 based on a specific value range (e.g., salary ranges, tax data). In some cases, System 100 may apply multiple filters or rules in sequence, wherein the data objects 108 may be required to meet multiple conditions before being assigned to a subset of data objects 116.

With continued reference to FIG. 1, the operations include generating a set of aggregated values 118 by aggregating at least one value of the one or more values 110 associated with each subset of data objects 116 of the one or more subsets of data objects 116. As used in the current disclosure, the set of aggregated values 118 refers to the collection of computed values that result from the aggregation process applied to the data within each subset of data objects 116. These aggregated values may represent insights derived from the raw values 110. The set of aggregated values 118 may include statistical measures such as sums, averages, counts, minimums, maximums, medians, and percentiles, among others.

The set of aggregated values 118 may be generated by aggregating at least one value of the one or more values 110 associated with each subset of data objects 116. The aggregation process involves applying aggregation functions (e.g., sum, average, count) to the relevant values within each subset. For example, if a subset of data objects 116 represents a group of employees and their salaries within a specific geographic region, the associated values 110 for this subset of data objects 116 may include the taxes paid by both the company and the employees. To generate an aggregated value 118, the system could compute the total tax amount for the region by summing the tax values across all the data objects 116 in that subset, resulting in an aggregated value 118 reflecting the taxes paid in that region.

With continued reference to FIG. 1, the operations include generating the set of aggregated values 118 using an aggregation engine 120. As used in the current disclosure, the aggregation engine 120 refers to a software component or system designed to perform analytic processes on the subsets of data objects 116. The primary function of the aggregation engine is to compute analytic metrics from the raw values 110 associated with each subset of data objects 116. This may be done by transforming large volumes of data into more concise, useful, and actionable information such as the set of aggregated values 118. The aggregation engine 120 may receive input data (such as the set of data objects 108 or subsets of data objects 116) and apply various analytical functions to produce a set of aggregated values 118.

The aggregation engine 120 may be designed to perform the aggregation process on a per-subset basis, meaning that it calculates the aggregated values 118 independently for each subset of data objects 116. By analyzing each subset of data objects 116 separately, System 100 can generate analytics for distinct groups of data, allowing for focused analysis on particular dimensions. For example, if the subsets of data objects 116 are defined based on geographical regions, the aggregation engine 120 may compute aggregated values 118 specific to each region. The subsets of data objects 116 could represent values 110 associated with different regions such as states, and the engine would calculate metrics such as total taxes paid on payroll, total payroll, or total number of employees within each state. The aggregation engine 120 may calculate the total payroll tax in each region by summing the payroll taxes paid by all employees in that region.

FIG. 2 illustrates an exemplary flow diagram of a method for training the aggregation engine 120 to generate the set of aggregated values 118.

At step 202, the method includes generating the set of aggregated values 118 using an aggregation engine 120, wherein the aggregation engine 120 includes a light machine-learning model. As used in the current disclosure, the light machine-learning model is a mathematical or algorithmic representation designed to analyze and process the relationships between various data parameters to generate the set of aggregated values 118.

The aggregation engine 120 may be configured to leverage machine-learning principles to make the aggregation process more flexible and intelligent. For example, it may employ supervised or unsupervised learning algorithms to recognize patterns in the data and select the most appropriate aggregation method based on the type of data and the analytic goals. For instance, it might determine when to apply summation, averaging, counting, or statistical aggregations like median or standard deviation based on the specific nature of the subset of data objects 116.

At step 204, the method includes training the aggregation engine 120 using training data. The training process aims to identify correlations among various subsets of data objects 116 which the aggregation engine 120 can later use to evaluate the data as needed. The training data may include a plurality of key pairs of historical or exemplary subsets of data objects 116 or aggregated values 118. By analyzing this data, the machine-learning model can identify relationships between these data points, such as the correlations between an exemplary subset of data objects 116 and the set of aggregated values 118. Training the aggregation engine 120 may facilitate the detection of these correlations and leverage them for future data structuring and decision-making.

The light machine-learning model may be trained on a variety of data types to learn which aggregation methods provide the most useful insights in different contexts. For instance, if the subset of data objects 116 represents financial transactions, the aggregation engine might learn that summing transaction values works best for total revenue while averaging transaction amounts might be better suited for determining average purchase size. Over time, as more data is fed into the system, the aggregation engine 120 may be iteratively refined to improve the quality of the output and reduce computing resources. This may include iteratively adjusting the biases and weights associated with the light machine-learning model.

The training data used for the light machine-learning model consists of multiple entries, each representing a collection of data parameters that are often correlated either through proximity within the data or other characteristics. For example, entries in the training data may indicate how specific subsets of data objects 116 should be aggregated to determine the aggregated values 118. The machine-learning model analyzes these correlations to detect trends or patterns that can then be used to make predictions or decisions when new data is processed. Through this analysis, the aggregation engine 120 learns the best way to aggregate subsets of data objects 116 to generate aggregated values 118. Furthermore, the training data can be structured to highlight specific relationships, such as how subsets of data objects 116 correlate with certain aggregated values 118. The aggregation engine 120 learns these patterns, allowing it to recognize similar patterns in incoming data and make intelligent decisions about how to generate the aggregated values 118.

In some cases, the training data may include data that is not explicitly categorized. The machine-learning model can handle this by using techniques such as correlation detection to identify hidden relationships within the data. This means that even if certain correlations are not directly labeled, the aggregation engine 120 can still generate the set of aggregated values 118 based on observed patterns and correlations within the existing data.

As part of the training process, the system may select refined training examples from a broader pool of data. These selected examples are meant to ensure that the aggregation engine 120 is exposed to a diverse set of scenarios and is not overfitting to a limited range of inputs. The selection ensures that the aggregation engine 120 can generalize well to various potential real-world situations. The training data might also include entries representing the most commonly encountered data distributions, ensuring that the aggregation engine 120 learns patterns that are representative of the data it is most likely to encounter when deployed.

Training the aggregation engine 120 may include iteratively adjusting its parameters, such as weights, biases, or coefficients, based on evaluations of predicted outcomes. This is accomplished by comparing the aggregation engine's 120 predicted output with the actual values from the training data, generating an error function to quantify the difference between the two. For example, the aggregation engine 120 might predict a specific set of aggregated values 118, and the error function will measure the discrepancy between the predicted and actual values. The error is typically squared to ensure that larger discrepancies are penalized more heavily.

Once the error function is calculated, the aggregation engine's 120 parameters are adjusted using optimization techniques like gradient descent or reinforcement learning. The goal of these techniques is to reduce the error over multiple iterations, fine-tuning the aggregation engine's 120 performance and improving its ability to generate accurate predictions. This iterative process helps the machine-learning model become more precise in generating the set of aggregated values 118.

The training process continues until the aggregation engine 120 reaches a satisfactory level of accuracy or convergence. Convergence is determined when the changes in the error function fall below a predefined threshold, indicating that the aggregation engine 120 has stabilized and no further significant improvements are expected. This is typically accompanied by the aggregation engine's 120 performance meeting specific criteria, such as the ability to generalize well to unseen data and provide accurate predictions for the set of aggregated values 118 based on new, incoming data.

At step 206, the method includes generating the set of aggregated values 118 by applying the trained light machine-learning model to each subset of data objects 116. After training, the aggregation engine 120 may use algorithms to analyze incoming each subset of data objects 116. The machine-learning model evaluates the similarity between new data and those it has encountered during training, allowing it to appropriately analyze and aggregate the subset of data objects 116 into aggregated values 118.

In an embodiment, the use of the light machine-learning model and the processes used to train the light machine-learning model may be applied to any machine-learning model or algorithm discussed herein, including but not limited to the accumulation engine 114.

With continued reference to FIG. 1, the operations include generating an aggregation report 122 based on the set of aggregated values 118. As used in the current disclosure, the aggregation report 122 is a structured summary or presentation of data that provides insights derived from aggregated values 118. The aggregation report 122 may be used to consolidate and analyze large volumes of raw data into meaningful, concise reports. The aggregation report 122 may include an analysis of data from multiple sources to produce a report that aggregates and analyzes the set of aggregated values 118.

In an embodiment, the aggregation report 122 may include an analysis of each subset of data objects 116. This analysis could be focused on a variety of dimensions, such as time periods (e.g., monthly, quarterly, annually), geographical regions, tax information, human resource data, or other relevant categorizations depending on the aggregation criteria applied. The aggregation report 122 may summarize the key findings from the aggregated data, highlighting trends, comparing different data subsets, and providing visualizations such as charts or graphs to help communicate the insights effectively.

In a non-limiting example, the aggregation report 122 may be generated from values 110 associated with tax data within the subset of data objects 116. This might include aggregated values 118 like total payroll taxes paid in different regions or the average salary within each department. It could also show how these values change over time or across specific employee classifications. The aggregation report 122 may provide high-level insights as well as a more granular breakdown.

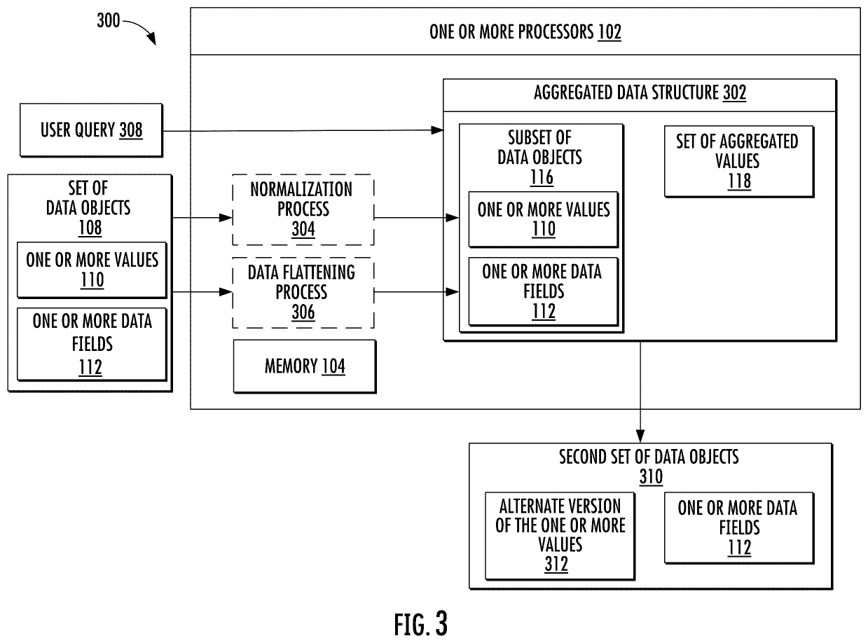

Referring now to FIG. 3 a block diagram of an exemplary system for generating and maintaining an aggregation data structure in accordance with embodiments of the present disclosure

The operations may include generating the aggregation data structure 302. As used in the current disclosure, the aggregation data structure 302 refers to a schema used to store and organize aggregated information derived from a collection of data objects. The aggregation data structure 302 may be used to both structure the raw data and the set of aggregated values 118. The aggregation data structure 302 may be used to efficiently manage large datasets, especially when multiple filtering criteria and aggregation functions are applied. By organizing data in this structured way, it ensures that the resulting aggregated values 118 are tied to the correct subsets of data objects 116.

The aggregation data structure 302 may be configured to structure not only the subset of data objects 116 and the set of aggregated values 118, but also to optimize the management of large datasets that undergo complex filtering and aggregation processes. To achieve this, the aggregation data structure 302 may be constructed with a schema that can support multiple data types, handle different aggregation methods, and link raw data to their corresponding aggregated metrics in a meaningful way.

The aggregation data structure 302 may be generated by identifying the key elements of the dataset that need to be organized. This may include any data discussed herein, including but not limited to the filtering criteria, aggregation functions, aggregation criteria 108a-b, data objects 108, subset of data objects 116, the set of aggregated values 118, metadata, and any other relevant data. The aggregation data structure 302 may be designed to hold these elements in a way that reflects the relationships between them, ensuring that aggregated values 118 can be tied back to the raw data objects they summarize. For instance, the aggregation data structure 302 may include fields for storing the original data objects, their associated filtering criteria, and the results of any applied aggregation functions

The aggregation data structure 302 may be composed of several components that work together to efficiently manage the data. It may include nested layers or hierarchical organization to reflect the relationships between different levels of data. For example, the top level could represent broader categories, such as geographical regions or time periods, with nested subsets of data objects 116 and their corresponding aggregated values 118 grouped within these categories. These nested subsets of data objects 116 may enable efficient retrieval of data, allowing for fast access to both the raw data and the aggregated metrics for analysis. Additionally, indexing mechanisms might be implemented within the structure to further enhance the speed of data access.

To create the aggregation data structure 302, the system first gathers all relevant data and applies the necessary filtering criteria to create distinct subsets. These subsets are then linked to specific aggregation criteria, such as summing, averaging, or counting values within each subset of data objects 116. Once the data is categorized and filtered, the system applies aggregation functions to compute summary values for each subset of data objects 116, storing these values in corresponding fields within the aggregation data structure. The structure may also include metadata about the aggregation process, such as the type of aggregation applied and any temporal or spatial considerations.

As new data is introduced, the aggregation data structure 302 may be expanded to include additional subsets of data objects 116 and newly computed aggregated values 118. The aggregation data structure 302 may be configured to be iteratively updated to incorporate new or modified data. In an embodiment, existing aggregated values may be recalculated based on updated data, ensuring that the aggregation data structure remains current and relevant.

Furthermore, the aggregation data structure 302 may be designed to support different types of aggregation and data. For example, it can handle both numeric data and categorical data. It may also support temporal analysis, where data is organized based on time periods, such as monthly, quarterly, or yearly aggregates.

With continued reference to FIG. 3, classifying the set of data objects 106 may include normalizing the set of data objects 108 or the subset of data objects 116 using a normalization process 304. As used in the current disclosure, the normalization process 304 refers to a series of steps used to standardize or adjust the data in such a way that it is consistent, comparable, and optimized for further analysis. Normalization may be a preprocessing step used to ensure that all data points within a dataset follow a uniform scale, unit of measurement, or format, which makes it easier to perform meaningful comparisons across different data objects. This process is particularly useful when dealing with heterogeneous data sources that may have different ranges, units, or formats.

The normalization process 304 may involve transforming the values 110 of the set of data objects 108 or the subset of data objects 116 into a common scale or format. For example, if the data includes variables that represent values like salary, payroll tax, or job title/job rank, normalization may adjust these values to eliminate discrepancies caused by differences in magnitude. This could involve scaling numerical data into a specific range, such as converting salaries to a standardized scale from 0 to 1, or transforming data based on a mathematical formula, such as dividing the value by the maximum value in the dataset to ensure comparability. In cases where data comes from multiple sources with varying units (e.g., payroll data in different currencies), normalization might also involve unit conversion to make the data uniform.

The normalization process 304 may involve converting values 110 of the set of data objects 108 or the subset of data objects 116 into a specific format. This may include formats such as CSV, Parquet, JSON, Feather file format, and the like. As used in the current disclosure, the feather file format is an efficient, lightweight, and highly optimized binary file format designed specifically for storing data frames in a way that is both fast to read and write. Feather files allow data to be stored with a columnar structure, which improves the performance of data operations such as data loading, manipulation, and conversion. Converting the values of the set of data objects 108 or the subset of data objects 116 into the feather file format may include serializing the data into this binary format for efficient storage and retrieval. This process may include transforming the dataset into a tabular structure with rows and columns.

Additionally, the normalization process 304 can include techniques such as min-max normalization, z-score normalization, or log transformations depending on the type of data and the desired output. For instance, min-max normalization scales all values to a fixed range, often between 0 and 1, making the data comparable across different subsets. Z-score normalization, on the other hand, adjusts the data based on the mean and standard deviation, which is useful for datasets where values are distributed around a central point but might vary widely. In cases where there are significant outliers in the data, log transformations can be used to compress the range of values and reduce the influence of these extreme data points, making it easier to identify patterns or trends in the data.

The normalization process 304 may be useful when combining data from different sources or systems. Since data objects within the subset of data objects 116 might come from a plurality of systems, companies, and/or databases, normalization ensures that the data conforms to a standardized format before being processed further. For example, if one system records salary data in thousands of dollars while another records it in actual dollars, the normalization process would convert both datasets into the same unit before aggregation.

In an embodiment, normalization process 304 may performed prior to the aggregation of the subset of data objects 116. Normalization may be useful when applying aggregation functions such as summing, averaging, or counting. Without normalization, aggregated values might be skewed by outliers or inconsistencies in the original data, leading to inaccurate conclusions. By normalizing the values associated with the subset of data objects 116, the system ensures that all data points are treated equally, regardless of the original range or scale of the data.

In some cases, the normalization process 304 may also involve handling missing or incomplete data. Normalization can include imputation techniques to fill in missing values, such as replacing missing data points with the mean, median, or mode of the available data, or using more sophisticated methods like interpolation. This ensures that the dataset is complete and that all values can be used effectively in subsequent aggregation and analysis.

With continued reference to FIG. 3, classifying the set of data objects 106 may include flattening the set of data objects 108 or the subset of data objects 116 using a data flattening process 306. As used in the current disclosure, the data flattening process 306 refers to a technique used to convert hierarchical or nested data structures into a simpler, tabular format. In its original form, data objects 108 may contain complex relationships, such as arrays, lists, or nested records, which are not directly suitable for most analytical tools or database systems. The flattening process 306 may transform these data objects into a two-dimensional table, where each column represents a specific attribute or value, and each row corresponds to a unique data instance. Flattening ensures that data, regardless of its original structure, can be efficiently processed, aggregated, or analyzed using standard methods such as SQL queries, spreadsheets, or data analysis frameworks like pandas.

During the data flattening process 306, the set of data objects 108 or the subset of data objects 116 may be transformed by breaking down any nested fields or arrays into discrete columns. For example, if a data object contains an array of human resource information, the flattening process would convert these nested arrays into individual columns, each representing a specific aspect of the original array. This transformation simplifies the original hierarchical data structure into a more linear format that can be more easily processed and analyzed. The flattened data is then structured in a way that each data record is represented as a single row, with each attribute in the record corresponding to a column.

In an embodiment, the operations may further comprise receiving a user query 308. The user query 308 may be designed to query the aggregation data structure 302. The content of the user query 308 may include various search parameters that are used to identify a value 110 associated with one or more data objects or aggregated value 118. These parameters may consist of specific identifiers, timestamps, metadata attributes, geographic regions, or other criteria relevant to the data objects or aggregated value 118. For instance, a user query 308 may request data related to a particular group of data objects associated with an aggregated value 118, such as data objects from a specific geographic region during a certain time frame.

The user query 308 can be received through various interfaces or channels provided by system 300. These interfaces may include web-based forms, application programming interfaces (APIs), chatbots, or other interactive tools that facilitate user input. The user queries 308 that are submitted via these interfaces may be transmitted to the system for processing. Upon receipt, System 300 may parse these queries to extract the relevant search parameters and criteria.

Once the query is received and parsed, the system 300 may perform a search within the aggregation data structure 302 based on the defined parameters. This search may include filtering and retrieving data objects or aggregated values 118 that match the criteria specified in the user query 308. The results of the search may be compiled and presented to the user.

In an embodiment, the operations may further comprise selecting at least one value 110 or aggregated value 118 from the aggregation data structure 302 as a function of the user query 308. This value 110 may be associated with the plurality of data objects 108 or the subset of data objects 116. The process of selecting the at least one value 110 may include filtering and identifying the subset of data objects 116 that correspond to the criteria specified in the user query 308. System 300 may apply logical operations and comparison algorithms to evaluate each data object or subset of data objects 116 against the query criteria.

In an embodiment, the operations further comprise constructing a second set of data objects 310 as a function of the selection. Constructing the second set of data objects 310 as a function of the selection process may include creating new data representations that reflect alternate versions of the one or more values 110. These alternate versions of the one or more values 110 may be derived from an alternate bitemporal timeline. The plurality of data objects 108 or the subset of data objects 116 may be the same or substantially similar to any data objects that are discussed herein This includes but is not limited to the plurality of data objects 108 or the subset of data objects 116 In an embodiment, the second set of data objects 310 may be used to reflect an alternate bitemporal timeline of the values 110 or the aggregated values 118. As used in the current disclosure, the alternate bitemporal timeline refers to a secondary temporal dimension that tracks the changes to the data from a different perspective or timeframe than the valid timeline. The valid timeline represents the chronological order and validity of data as it applies to real-world events, while the alternate bitemporal timeline may track historical data, hypothetical scenarios, or alternative records within the system. By creating the second set of data objects 310 based on this alternate timeline, the system enables users to view and analyze data from these different temporal contexts.

In a non-limiting example, the valid timeline may represent an actual aggregated value 118, which may reflect the payroll taxes paid by an entity during the fourth quarter of 2020. An alternate bitemporal timeline, on the other hand, may show how this aggregated value 118 would change if the company had implemented a 10 percent workforce layoff prior to the fourth quarter of 2020. This use of the alternate bitemporal timeline tracks a hypothetical scenario in which the entity's workforce is reduced by 10 percent. To support this alternate timeline, the system 300 constructs a second set of data objects 310 to represent the aggregated value 118 under the hypothetical scenario. The second set of data objects 310 may depict alternative versions of the aggregated value 118, starting from the fourth quarter of 2020 based on the modified timeline.

In some cases, constructing the second set of data objects 310 may include forecasting the alternate version of the one or more values to a target date. Forecasting the alternate version of one or more values to a target date may involve projecting data into the future based on alternate bitemporal timelines to anticipate potential outcomes and scenarios. The process may begin with defining the target date and the parameters of the alternate bitemporal timeline. The target date is the future point in time at which the forecasted values will be assessed. The target date may be received from the user or may be generated by system 300.

System 300 may utilize predictive analytics and forecasting models to estimate how the one or more values 110 will change over time based on the alternate bi-temporal timeline. This may involve applying statistical techniques and algorithms that consider historical data, trends, and the specific parameters of the alternate timeline. In an embodiment, a machine-learning model or algorithm may be used to generate the forecasted values.

Once the forecasted values are generated, the second set of data objects 310 may be created to represent the alternate version of the values projected to the target date. These data objects that reflect the forecasted values may be designed to provide a preview of the expected outcomes under the alternate scenario.

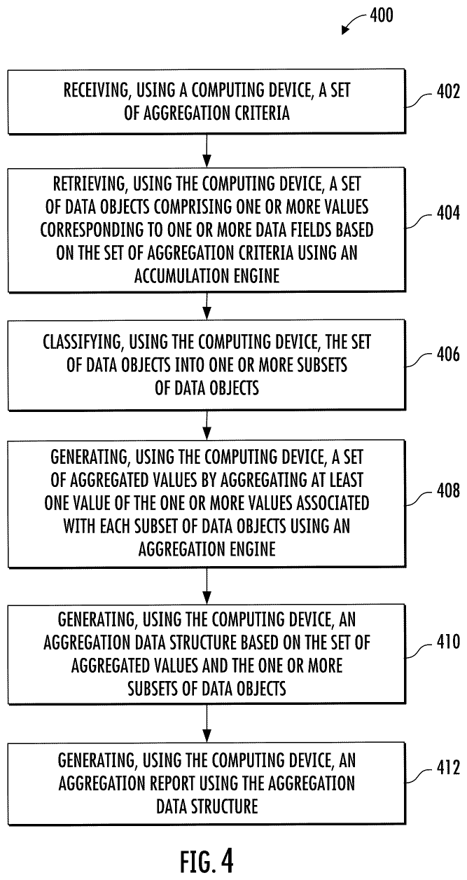

Referring now to FIG. 4, a flow diagram of an exemplary method for generating an aggregation report based on a set of aggregated values in accordance with embodiments of the present disclosure.

At step 402, the method includes receiving, using a computing device, a set of aggregation criteria. In an embodiment, the set of aggregation criteria may serve as predefined rules that determine which data objects should be selected for processing or analysis. Using the aggregation criteria, the computing system can selectively focus on specific subsets of data, which improves both the speed and relevance of subsequent analyses. In some cases, the aggregation criteria can be customizable depending on the specific use case or business requirements. For example, the aggregation criteria may be based on employee classification (e.g., full-time versus part-time) to generate reports or insights only for certain types of workers. Similarly, the aggregation criteria may be based on geographical regions or temporal windows to track regional performance over time.

At step 404, the method includes retrieving, using the computing device, a set of data objects comprising one or more values corresponding to one or more data fields based on the set of aggregation criteria. In an embodiment, the process of retrieving data objects may include searching or filtering a dataset to identify the data objects that meet the specified conditions of the set of aggregation criteria. This dataset may be located on a computing device that is external to system 100. In some cases, retrieving the set of data objects may include querying a data storage system, such as a relational database, data warehouse, or cloud storage, where the data objects are stored.

In an embodiment, the method may include normalizing, using the computing device, the set of data objects using a normalization process. The normalization process may be used to ensure that the retrieved data objects are consistent, standardized, and ready for analysis. The normalization process may be used to combat inconsistencies in the format, scale, or units of the data across different sources or records. Data normalization can involve transforming the inconsistencies within the data objects into a common format or scale, which can involve standardizing numerical values, correcting inconsistencies in data types, and harmonizing categorical data. This process is particularly important when the data is drawn from multiple sources or when it spans different systems or databases.

In an additional embodiment, the method may further comprise flattening, using the computing device, the set of data objects using a data flattening process. The data flattening process may include transforming nested or hierarchical data structures into a flat, two-dimensional format, often in the form of tables or spreadsheets. The un-flattened data objects may be organized in complex formats where information is stored in multiple layers or nested fields. The data flattening process may be used to simplify this data by breaking down these nested structures and representing each attribute as a separate column, thereby making the data object easier to analyze, process, or input into machine learning models.

A machine learning model may be used to enact the data normalization or data flattening process by learning patterns and relationships within the data to standardize and simplify it effectively. For example, the model can be trained on historical datasets to identify common discrepancies in data formats, units, file structures, or values, and learn the most effective transformation methods for normalizing these inconsistencies or flattening hierarchical data. In the case of data flattening, the model can be trained to recognize nested or complex data structures and convert them into a flat, tabular form, separating nested fields into distinct columns. A supervised learning approach may be employed, where labeled training data teaches the machine learning model how to correctly normalize data objects and their associated values, or how to flatten nested data structures into a format that can be easily processed. This may involve transforming a complex, multi-layered dataset into individual attributes, ensuring each data point is represented as a unique row with accessible attributes. In some cases, the model may be iteratively trained to learn from the data distribution, applying transformations like scaling, logarithmic adjustments, min-max normalization, or flattening nested fields to bring the data onto a consistent scale or format. Unsupervised learning techniques may also be used to help identify outliers or data entries that deviate from expected norms, prompting necessary adjustments or structural changes. In an embodiment, this machine learning model may be trained using any training data or training process described within the disclosure, including but not limited to the process described herein in FIG. 2.

At step 406, the method includes classifying, using the computing device, the set of data objects into one or more subsets of data objects. Classifying a set of data objects into one or more subsets of data objects may include categorizing or clustering the data objects based on predefined criteria or patterns identified within the data. The classification process may leverage machine learning or rule-based algorithms to analyze the characteristics or features of each data object and assign it to a specific subset of data objects. The classification process may include identifying relevant features or attributes of the data, which can be used to distinguish between different subsets of data objects. The machine learning model or algorithm may be trained using labeled or unlabeled training data. Exemplary training data may include data objects that already belong to specific categories or subsets. The machine learning model may be configured to learn patterns from the labeled data and apply this knowledge to classify new, unlabeled data objects. In some cases, unsupervised machine-learning techniques might be employed when the data lacks predefined labels. These unsupervised machine-learning techniques may be used to automatically identify natural groupings or patterns in the dataset without prior knowledge of the categories.

At step 408, the method includes generating, using the computing device, a set of aggregated values by aggregating at least one value of the one or more values associated with each subset of data objects of the one or more subsets of data objects using an aggregation engine. Generating the set of aggregated values may include applying specific operations to the data objects in order to summarize or consolidate multiple data points into a smaller, more meaningful set of results. This may be done by aggregating values associated with each subset of data objects. To aggregate values, the system may process the values within each subset of data objects using functions like sum, average, count, minimum, maximum, median, percentile, and the like. For example, in a scenario where the data objects represent employee salaries across regions, the aggregation process could sum the tax payments made by employees in each region, thereby producing a single aggregated value that represents the total tax contribution for that region.

The generation of aggregated values may be facilitated by an aggregation engine, which may be used to transform the raw values of the data objects into aggregated values. The aggregation engine performs its calculations independently for each subset of data objects, ensuring that the analysis is tailored to the specific characteristics of the subset. This allows for a focused analysis of distinct dimensions, such as geographical regions or categories. For instance, if the subsets of data objects are divided by states, the aggregation engine computes metrics like the total payroll tax or the number of employees per state, producing aggregated values that are specific to each geographic area.

At step 410, the method includes generating, using the computing device, an aggregation data structure based on the set of aggregated values and one or more subsets of data objects. The aggregation data structure may be a data structure designed to store and organize both raw data objects and the aggregated values derived from them. The aggregation data structure may be configured to store any data disclosed herein, including but not limited to the raw data objects and aggregated values. The aggregation data structure may be created by organizing the raw data objects into subsets based on certain criteria or dimensions. These criteria could be categories like geographic regions, product types, time periods, and the like. Once the subsets are defined, the aggregation engine processes each subset of data objects independently, applying aggregation functions (e.g., sum, average, count) to the relevant values within the subset. The aggregation data structure can be implemented as a multi-level hierarchy or a tree-like structure where each node represents a subset, and the leaves contain the aggregated values.

In an embodiment, the aggregation data structure may be configured to access and store both the data objects and the aggregated values. This may be done using a key-value store or a hash table where each subset of data objects is a key, and the corresponding value is either a list of raw data objects or an object containing aggregated values. Alternatively, hierarchical data structures like trees or nested dictionaries can be employed, where each level represents a deeper granularity of aggregation. For example, a tree might have nodes for broader categories (e.g., “Country”) and child nodes for more granular subsets (e.g., “State”). Each leaf node in the tree stores the aggregated values for the respective subset.

In some cases, the aggregation data structure may be used to select one or more values associated with a data object or an aggregated value based on a user query. Once the relevant aggregated values are selected, the system can then construct a second set of data objects that represents an alternate version of the selected values. This alternate version could involve forecasting future trends, such as projecting sales to a target date based on historical data. The computing device may apply forecasting models to adjust the selected aggregated values, generating a set of updated or predicted values. For example, the system might forecast the total sales in a region by analyzing past performance and applying time-series analysis to predict future outcomes.

At step 412, the method includes generating, using the computing device, an aggregation report using the aggregation data structure. An aggregation report may be a document or output that summarizes large volumes of raw data into a more digestible format. The aggregation report may be used to present key metrics and statistics derived from the set of data objects and the aggregated values.

In an embodiment, the aggregation report may be leveraged to automatically populate a government form by streamlining the process of extracting and organizing relevant data for submission. The aggregation report may serve as an intermediary between raw data sources and the required form fields. The aggregated values and metrics within the form may be inserted into the corresponding fields of the government form, reducing manual data entry errors and ensuring consistency. By using predefined templates, the aggregation report ensures that all relevant information is accurately mapped to the correct form sections.

### Embodiment 1

A system for generating an aggregation report based on a set of aggregated values, comprising: one or more processors; and one or more transitory or non-transitory computer-readable media storing instructions that are executable to cause the one or more processors to perform operations, the operations comprising: receiving a set of aggregation criteria; retrieving a set of data objects comprising one or more values corresponding to one or more data fields based on the set of aggregation criteria; classifying the set of data objects into one or more subsets of data objects; generating a set of aggregated values by aggregating at least one value of the one or more values associated with each subset of data objects of the one or more subsets of data objects using an aggregation engine; and generating an aggregation report based on the set of aggregated values.

### Embodiment 2

The system of embodiment 1, wherein: retrieving the set of data objects further comprises retrieving the set of data objects using an accumulation engine; and generating the set of aggregated values comprises generating the set of aggregated values using an aggregation engine.

### Embodiment 3

The system of embodiment 1, wherein the operations comprise normalizing the set of data objects using a normalization process.

### Embodiment 4

The system of embodiment 3, wherein normalizing the set of data objects includes converting the set of data objects into feather file format.

### Embodiment 5

The system of embodiment 1, wherein the operations comprise flattening the set of data objects using a data flattening process.

### Embodiment 6

The system of embodiment 1, wherein the operations further comprise generating an aggregation data structure based on the set of aggregated values and the set of data objects.

### Embodiment 7

The system of embodiment 6, wherein the operations further comprise: receiving a user query; selecting at least one value from the aggregation data structure as a function of the user query; and constructing a second set of data objects as a function of the selection, wherein the second set of data objects comprises an alternate version of the at least one value.

### Embodiment 8

The system of embodiment 7, wherein constructing the second set of data objects comprises forecasting the alternate version of the one or more values to a target date.

### Embodiment 9

The system of embodiment 1, wherein the operations are performed by the one or more processors of a single computing device.

### Embodiment 10

A method for generating an aggregation report based on a set of aggregated values, wherein the method comprises: receiving, using a computing device, a set of aggregation criteria; retrieving, using the computing device, a set of data objects comprising one or more values corresponding to one or more data fields based on the set of aggregation criteria using an accumulation engine; classifying, using the computing device, the set of data objects into one or more subsets of data objects; generating, using the computing device, a set of aggregated values by aggregating at least one value of the one or more values associated with each subset of data objects of the one or more subsets of data objects using an aggregation engine; generating, using the computing device, an aggregation data structure based on the set of aggregated values and the one or more subsets of data objects; and generating, using the computing device, an aggregation report using the aggregation data structure.

### Embodiment 11

The method of embodiment 10, wherein the method further comprises normalizing, using the computing device, the set of data objects using a normalization process.

### Embodiment 12

The method of embodiment 11, wherein normalizing the set of data objects includes converting the set of data objects into feather file format.

### Embodiment 13

The method of embodiment 10, wherein the method further comprises flattening, using the computing device, the set of data objects using a data flattening process.

### Embodiment 14

The method of embodiment 10, wherein the method further comprises: receiving, using a computing device, a user query; selecting, using the computing device, at least one value from the aggregation data structure as a function of the user query; and constructing, using the computing device, a second set of data objects as a function of the selection, wherein the second set of data objects comprises an alternate version of the at least one value.

### Embodiment 15

The method of embodiment 14, wherein constructing the second set of data objects comprises forecasting the alternate version of those one or more values to a target date.

### Embodiment 14

The method of embodiment 10, wherein the aggregation engine includes a light machine-learning model.

### Embodiment 17

A system for generating an aggregation report based on a set of aggregated values, wherein the system comprises: one or more processors; and one or more transitory or non-transitory computer-readable media storing instructions that are executable to cause the one or more processors to perform operations, the operations comprising: receiving a set of aggregation criteria; retrieving a set of data objects comprising one or more values corresponding to one or more data fields based on the set of aggregation criteria using an accumulation engine; classifying the set of data objects into one or more subsets of data objects, classifying the set of data objects comprises: normalizing the set of data objects using a normalization process; and flattening the normalized set of data objects using a data flattening process; generating a set of aggregated values by aggregating at least one value of the one or more values associated with each subset of data objects of the one or more subsets of data objects using an aggregation engine; generating an aggregation data structure based on the set of aggregated values and the one or more subsets of data objects; generating an aggregation report using the aggregation data structure.

### Embodiment 19

The system of embodiment 18, wherein constructing the second set of data objects comprises forecasting the alternate version of the one or more values to a target date.

### Embodiment 20

The system of embodiment 17, wherein the operations are performed by the one or more processors of a single computing device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for generating an aggregation report based on a set of aggregated values, comprising:
one or more processors; and
one or more transitory or non-transitory computer-readable media storing instructions that are executable to cause the one or more processors to perform operations, the operations comprising:
receiving a set of aggregation criteria;
retrieving, using a parallel collection strategy, a set of data objects comprising one or more values corresponding to one or more data fields based on the set of aggregation criteria, wherein retrieving the set of data objects using the parallel collection strategy comprises:
asynchronously retrieving one or more data objects from one or more sources of a plurality of sources; and
incrementally processing each retrieved data object to generate the set of data objects, wherein each retrieved data object is processed as the retrieved data object is received without waiting for responses from all of the plurality of sources;
processing, using a machine learning model, the set of data objects to generate a flattened set of data objects using a data flattening process, wherein generating the flattened set of data objects comprises transforming each data object within the set of data objects into a tabular flatted representation;
classifying the flattened set of data objects into one or more subsets of data objects;
generating a set of aggregated values by aggregating at least one value of the one or more values associated with each subset of data objects of the one or more subsets of data objects using an aggregation engine; and
generating an aggregation report based on the set of aggregated values.

2. The system of claim 1, wherein:
retrieving the set of data objects further comprises retrieving the set of data objects using an accumulation engine; and
generating the set of aggregated values comprises generating the set of aggregated values using an aggregation engine.

3. The system of claim 1, wherein the operations comprise normalizing the set of data objects using a normalization process.

4. The system of claim 3, wherein normalizing the set of data objects includes converting the set of data objects into feather file format.

5. (canceled)

6. The system of claim 1, wherein the operations further comprise generating an aggregation data structure based on the set of aggregated values and the set of data objects.

7. The system of claim 6, wherein the operations further comprise:
receiving a user query;
selecting at least one value from the aggregation data structure as a function of the user query; and
constructing a second set of data objects as a function of the selection, wherein the second set of data objects comprises an alternate version of the at least one value.

8. The system of claim 7, wherein constructing the second set of data objects comprises forecasting the alternate version of the one or more values to a target date.

9. The system of claim 1, wherein the one or more processors are comprised of a single computing device.

10. A method for generating an aggregation report based on a set of aggregated values, wherein the method comprises:
receiving, using a computing device, a set of aggregation criteria;
retrieving, using a parallel collection strategy executed by the computing device, a set of data objects comprising one or more values corresponding to one or more data fields based on the set of aggregation criteria using an accumulation engine, wherein retrieving the set of data objects using the parallel collection strategy comprises:
asynchronously retrieving one or more data objects from one or more sources of a plurality of sources; and
incrementally processing each retrieved data object to generate the set of data objects, wherein each retrieved data object is processed as the retrieved data object is received without waiting for responses from all of the plurality of sources;
processing, using a machine learning model, the set of data objects to generate a flattened set of data objects using a data flattening process, wherein generating the flattened set of data objects comprises transforming each data object within the set of data object into a tabular flatted representation;
classifying, using the computing device, the flattened set of data objects into one or more subsets of data objects;
generating, using the computing device, a set of aggregated values by aggregating at least one value of the one or more values associated with each subset of data objects of the one or more subsets of data objects using an aggregation engine;
generating, using the computing device, an aggregation data structure based on the set of aggregated values and the one or more subsets of data objects; and
generating, using the computing device, an aggregation report using the aggregation data structure.

11. The method of claim 10, wherein the method further comprises normalizing, using the computing device, the set of data objects using a normalization process.

12. The method of claim 11, wherein normalizing the set of data objects includes converting the set of data objects into feather file format.

13. (canceled)

14. The method of claim 10, wherein the method further comprises:
receiving, using a computing device, a user query;
selecting, using the computing device, at least one value from the aggregation data structure as a function of the user query; and
constructing, using the computing device, a second set of data objects as a function of the selection, wherein the second set of data objects comprises an alternate version of the at least one value.

15. The method of claim 14, wherein constructing the second set of data objects comprises forecasting the alternate version of the one or more values to a target date.

16. The method of claim 10, wherein the aggregation engine includes a light machine-learning model.

17. A system for generating an aggregation report based on a set of aggregated values, comprising:
one or more processors; and
one or more transitory or non-transitory computer-readable media storing instructions that are executable to cause the one or more processors to perform operations, the operations comprising:
receiving a set of aggregation criteria;
retrieving, using a parallel collection strategy, a set of data objects comprising one or more values corresponding to one or more data fields based on the set of aggregation criteria using an accumulation engine, wherein retrieving the set of data objects using the parallel collection strategy comprises:
asynchronously retrieving one or more data objects from one or more sources of a plurality of sources; and
incrementally processing each retrieved data object to generate the set of data objects, wherein each retrieved data object is processed as the retrieved data object is received without waiting for responses from all of the plurality of sources;
classifying the set of data objects into one or more subsets of data objects, classifying the set of data objects comprises:
normalizing the set of data objects using a normalization process; and
flattening, using a machine learning model, the normalized set of data objects using a data flattening process, wherein flattening the normalized set of data objects comprises transforming each data object within the normalized set of data object into a tabular flatted representation;
generating a set of aggregated values by aggregating at least one value of the one or more values associated with each subset of data objects of the one or more subsets of data objects using an aggregation engine
generating an aggregation data structure based on the set of aggregated values and the one or more subsets of data objects;
generating an aggregation report using the aggregation data structure.

18. The system of claim 17, wherein the operations further comprise:
receiving a user query;
selecting at least one value from the aggregation data structure as a function of the user query; and
constructing a second set of data objects as a function of the selection, wherein the second set of data objects comprises an alternate version of the at least one value.

19. The system of claim 18, wherein constructing the second set of data objects comprises forecasting the alternate version of the one or more values to a target date.

20. The system of claim 17, wherein the one or more processors are comprised of a single computing device.

21. (canceled)

22. The system of claim 7, wherein the second set of data objects reflects an alternate bitemporal timeline, wherein the alternate bitemporal timeline forecasts the alternate version of the at least one value to a target date in the future based on parameters of the alternate bitemporal timeline.
